(19) United States
(12) Patent Application Publication
(10) Pub. No.: US 2026/0330242 A1
(43) Pub. Date: Oct. 22, 2026

(54) LEARNING SYSTEM, LEARNING METHOD, AND COMPUTER READABLE MEDIUM

(71) Applicant: NEC Corporation, Minato-ku, Tokyo (JP)

(72) Inventor: Takeshi AKAGAWA, Tokyo (JP)

(73) Assignee: NEC Corporation, Minato-ku, Tokyo (JP)

(21) Appl. No.: 18/994,805

(22) PCT Filed: Aug. 10, 2022
(86) PCT No.: PCT/JP2022/030623

§ 371 Date: Jan. 15, 2025

(51) Int. Cl. G06N 3/098

(52) U.S. Cl. CPC G06N 3/098

(57) ABSTRACT

A learning system includes: an acquisition unit configured to acquire blurred data for blurring predetermined data included in data sets owned by respective organizations; a learning unit configured to learn local models by machine learning performed using the blurred data and the data sets; and a generation unit configured to generate a global model in federated learning based on the local models.

### TECHNICAL FIELD

The present disclosure relates to a learning system, a learning method, and a computer readable medium.

### BACKGROUND ART

Patent Literature 1 discloses a system including calculation models for performing machine learning.

### CITATION LIST

### Patent Literature

[Patent Literature 1] Japanese Unexamined Patent Application Publication No. 2019-144872

### SUMMARY OF INVENTION

### Technical Problem

A federated learning technique for integrating local models trained using data sets owned by respective organizations to generate a global model has been proposed. In the federated learning technique, as only the generated global model is distributed, it is possible to keep the data sets used for learning confidential. However, if there is an organization that records a time-series change in the global model, it may be possible for this organization to infer learning data used to learn the most recent local model by reverse engineering the global model.

In view of the above circumstances, one of objects of example embodiments herein disclosed is to provide a learning system, a learning method, and a program for preventing learning data used for federated learning from being inferred.

### Solution to Problem

A learning system according to a first aspect of the present disclosure includes: acquisition means for acquiring blurred data for blurring predetermined data included in data sets owned by respective organizations; learning means for learning local models by machine learning performed using the blurred data and the data sets; and generation means for generating a global model in federated learning based on the local models.

A learning method according to a second aspect of the present disclosure includes: acquiring blurred data, which is data for blurring predetermined data included in data sets owned by respective organizations; causing local models to be learned by machine learning performed using the blurred data and the data sets; and generating a global model in federated learning based on the local models.

A non-transitory computer readable medium according to a third aspect of the present disclosure stores a program for causing a computer to execute: processing for acquiring blurred data, which is data for blurring predetermined data included in data sets owned by respective organizations; processing for causing local models to be learned by machine learning performed using the blurred data and the data sets; and processing for generating a global model in federated learning based on the local models.

### Advantageous Effects of Invention

According to the present disclosure, it is possible to provide a learning system, a learning method, and a program for preventing learning data used for federated learning from being inferred.

### BRIEF DESCRIPTION OF DRAWINGS

FIG. 1 is a block diagram showing a configuration of a learning system according to related art;

FIG. 2 is a block diagram showing a configuration of a learning system according to a first example embodiment;

FIG. 3 is a block diagram showing a configuration of a learning system according to a second example embodiment;

FIG. 4 is a block diagram showing a configuration of a client terminal according to the second example embodiment;

FIG. 5 is a flowchart showing a flow of an operation of an acquisition unit;

FIG. 6 is a block diagram showing a configuration of a client terminal according to a third example embodiment; and

FIG. 7 is a block diagram showing a configuration of a learning system according to a fourth example embodiment.

### EXAMPLE EMBODIMENT

### Circumstances Leading to Example Embodiments

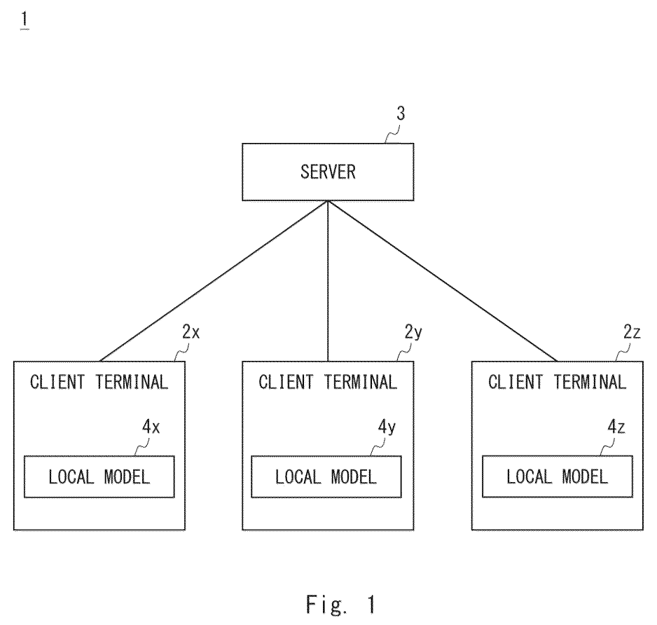

First, an outline of federated learning will be described. Referring first to FIG. 1, a configuration of a learning system 1 according to related art will be described. The learning system 1 includes a client terminal 2x, a client terminal 2y, a client terminal 2z, and a server 3.

The client terminal 2x generates a machine learning model (this model will be referred to as a local model 4x) from a data set owned by an organization X. The client terminal 2x transmits the local model 4x to the server 3.

The client terminal 2y generates a machine learning model (this model will be referred to as a local model 4y) from a data set owned by an organization Y. The client terminal 2y transmits the local model 4y to the server 3.

The client terminal 2z generates a machine learning model (this model will be referred to as a local model 4z) from a data set owned by an organization Z. The client terminal 2z transmits the local model 4z to the server 3.

The server 3 generates a global model in which the local model 4x, the local model 4y, and the local model 4z are integrated. The server 3 may calculate, for example, an arithmetic mean of model parameters of the local models 4x, 4y, and 4z. Note that a method for integrating the model parameters is not limited to the arithmetic mean. The server 3 then distributes the global model to the client terminals 2x, 2y, and 2z.

Here, it is possible that data sets owned by respective organizations may include data that needs to be kept confidential from other organizations (e.g., data of a compound that is being developed). For example, there may be a case where one organization has started development of a compound that exhibits a specific effect and wants to keep this information secret. However, since the data set owned by this organization includes a large amount of data of the compound that exhibits the specific effect, it is possible that the start of development of the compound may be inferred by reverse engineering the global model. The inventors of the present application have conceived of the invention according to a first example embodiment based on the aforementioned circumstances.

### First Example Embodiment

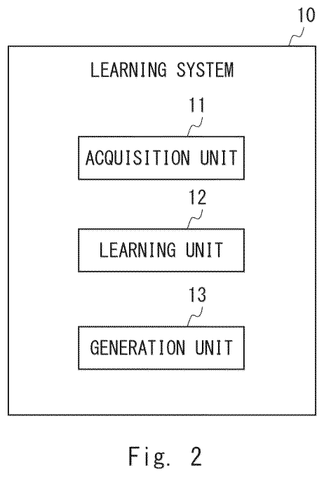

FIG. 2 is a block diagram showing a configuration of a learning system 10 according to a first example embodiment. The learning system 10 includes an acquisition unit 11, a learning unit 12, and a generation unit 13.

The acquisition unit 11 acquires blurred data for blurring predetermined data included in data sets owned by respective organizations. The learning unit 12 learns local models by machine learning performed using blurred data and the data sets. The generation unit 13 generates a global model in federated learning based on the local models learned in the learning unit 12.

Since the learning system 10 according to the first example embodiment learns local models using blurred data, it is possible to prevent learning data used for federated learning from being inferred.

Note that the learning system 10 includes, as components that are not shown, a processor, a memory, and a storage apparatus. Further, this storage apparatus stores a computer program in which processing of a learning method according to this example embodiment is implemented. Then the processor loads a computer program into the memory from the storage apparatus to execute this computer program. Accordingly, the processor implements functions of the acquisition unit 11, the learning unit 12, and the generation unit 13.

Alternatively, each of the acquisition unit 11, the learning unit 12, and the generation unit 13 may be implemented by special-purpose hardware. Further, some or all of the components of each apparatus may each be implemented by a general-purpose or special-purpose circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a Field-Programmable Gate Array (FPGA), and so on may be used as the processor.

Further, in a case where some or all of the components of the learning system 10 are implemented by a plurality of information processing apparatuses, circuits, or the like, the plurality of information processing apparatuses, the circuits, or the like may be disposed in one place in a centralized manner or arranged in a distributed manner. For example, the information processing apparatuses, the circuits, and the like may be implemented as a form such as a client-server system, a cloud computing system or the like in which they are connected to each other through a communication network. Further, the functions of the learning system 10 may be provided in the form of Software as a Service (Saas).

### Second Example Embodiment

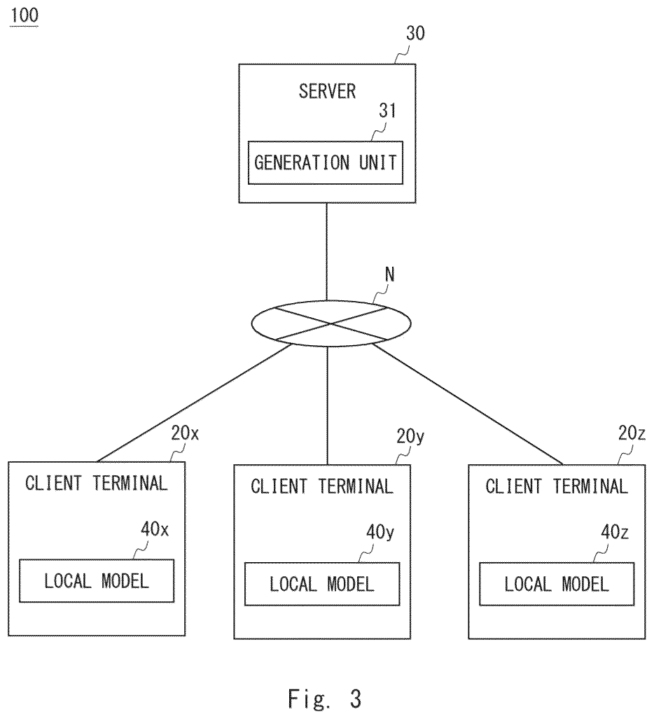

A learning system 100 according to a second example embodiment is a specific example of the learning system 10 according to the first example embodiment. FIG. 3 is a block diagram showing a configuration of the learning system 100. The learning system 100 includes a client terminal 20x, a client terminal 20y, a client terminal 20z, and a server 30. Each of the client terminals is a terminal of an organization that uses the learning system 100 (e.g., a pharmaceutical or chemical company).

The client terminals 20x, 20y, and 20z and the server 30 are connected to each other in such a way that they can communicate with one another via a network N. The network N may be a wired network or a wireless network. The network N may be, for example, a Virtual Private Network (VPN).

In the following description, if it is not necessary to distinguish between the client terminals 20x, 20y, and 20z, they may be simply referred to as a client terminal 20. Note that the number of client terminals 20 is not limited to three, and it may be two, or four or greater.

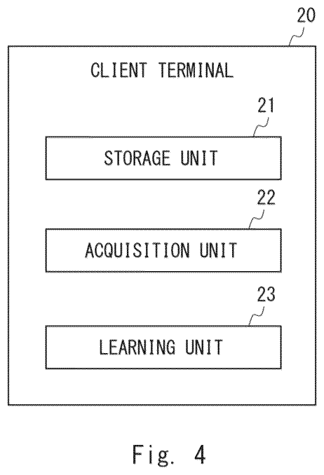

Referring next to FIG. 4, the client terminal 20 will be described. The client terminal 20 includes a storage unit 21, an acquisition unit 22, and a learning unit 23. The acquisition unit 22 is a specific example of the aforementioned acquisition unit 11, and the learning unit 23 is a specific example of the aforementioned learning unit 12.

The storage unit 21 is a storage that stores data sets owned by respective organizations. Each data set is, for example, a data set of compounds. In this case, values indicating a structure, characteristics, and the like of each compound are arranged in each data set. The structure of each compound is represented by a bit string or the like having a fixed length, and each bit of the bit string represents the presence or absence of a predetermined structure (e.g., benzene ring). Property values (e.g., a value of a tensile strength) may be values obtained by experiments or may be values obtained by a simulation or theoretical calculation.

Each data set includes predetermined data. The predetermined data is data that needs to be kept confidential. The predetermined data is, for example, data of a compound that exhibits a specific effect.

The storage unit 21 may store, in addition to data sets, original data of blurred data. The storage unit 21 may store, for example, experimental data, theoretical calculation data, simulation data, data used for materials informatics, and so on.

The acquisition unit 22 acquires blurred data for blurring predetermined data included in a data set. The blurred data is different from the predetermined data, and needs to be data that does not deteriorate the performance of local models.

In a case where the predetermined data is data of a compound that exhibits a specific effect (e.g., a compound which is under development), the blurred data may be data of a compound that exhibits an effect other than the specific effect (this compound will be referred to as a first compound). In a case where, for example, the compound that exhibits the specific effect is a compound used as headache medication, the first compound may be a compound used as abdominal pain medication.

Note that the aforementioned data set is not limited to a data set of compounds. In a case where the data set includes data of a matter related to business of each organization, the predetermined data may be data regarding a matter having a specific attribute (e.g., effect) and the blurred data may be data regarding a matter having an attribute other than the specific attribute. The matter may be, for example, a compound or a financial instrument. The blurred data is not necessarily actual data, and may be data estimated by a simulation or the like.

For example, if an organization conducts research or studies on a matter (e.g., a compound, a financial instrument) with specific attributes, this organization may want to keep secret that it is conducting research or studies. With the second example embodiment, the organization can keep the object (intention) of the investigation or the research confidential.

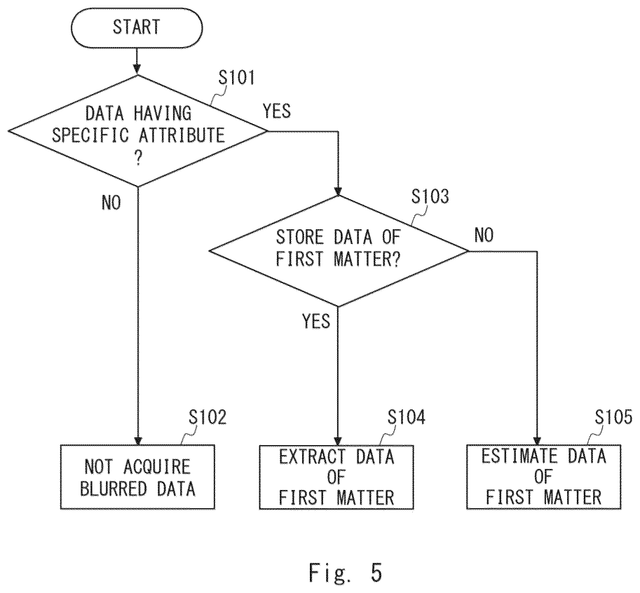

Referring next to FIG. 5, a flow of an operation of the acquisition unit 22 will be described. A data set includes a plurality of records, and each record is called data or a data item.

The acquisition unit 22 performs the following processing on each data item included in the data set. First, the acquisition unit 22 determines whether or not the data item is data of a matter having a specific attribute (Step S101). In a case where the data item is not data of a matter having a specific attribute (NO in Step S101), the acquisition unit 22 does not acquire blurred data (Step S102), and moves to processing on the next data item.

In a case where the data item is data of a matter having a specific attribute (YES in Step S101), the acquisition unit 22 determines whether or not the storage unit 21 stores data of a matter having an attribute other than the specific attribute (this matter will be referred to as a first matter) (Step S103). Note that the first compound is a specific example of the first matter.

In a case where data of the first matter is stored (Yes in Step S103), the acquisition unit 22 extracts the data of the first matter from the data stored in the storage unit 21 (Step S104). The acquisition unit 22 acquires the extracted data of the first matter as blurred data, and then transits to processing on the next data.

In a case where data of the first matter is not stored (NO in Step S103), the acquisition unit 22 estimates the data of the first matter based on the data stored in the storage unit 21 (Step S105). Then, the acquisition unit 22 acquires the estimated data of the first matter as blurred data, and then transits to processing on the next data. The acquisition unit 22 may estimate data of a first compound based on, for example, materials informatics or theoretical calculation.

Referring once again to FIG. 4, the learning unit 23 learns local models by machine learning performed using the blurred data acquired by the acquisition unit 22 and the data sets. The local model learned in the client terminal 20x is referred to as a local model 40x, the local model learned in the client terminal 20y is referred to as a local model 40y, and the local model learned in the client terminal 20z is referred to as a local model 40z. If it is not necessary to distinguish between the local models 40x, 40y, and 40z, they are simply referred to as a local model 40. The local model 40 may be, for example, a model for inferring properties from a structure of a compound. The learning unit 23 transmits the learned local model 40, that is, a parameter of the local model 40 to the server 30.

With reference to FIG. 3, the server 3 will be described. The server 3 includes a generation unit 31. The generation unit 31 generates a global model in which the local model 40x, the local model 40y, and the local model 40z are integrated. The generation unit 31 is a specific example of the generation unit 13 described above. The generation unit 31 distributes the global model in which the local model 40x, the local model 40y, and the local model 40z are integrated to the client terminals 20x, 20y, and 20z.

Note that the server 30 may store data sets owned by respective organizations, generate local models 40x, 40y, and 40z, and integrate the local models 40x, 40y, and 40z. In this case, the acquisition unit 22 and the learning unit 23 are provided in the server 30.

The learning system 100 according to the second example embodiment learns local models using blurred data for blurring predetermined data. It is therefore possible to prevent other organizations from estimating predetermined data from the global model.

### Third Example Embodiment

In the second example embodiment, in generation of local models, blurred data and actual data included in data sets are not distinguished from each other. In the third example embodiment, a weight of blurred data in machine learning (this weight will be referred to as a first weight) and a weight of actual data (this weight will be referred to as a second weight) are made different from each other. Since a parameter of a machine learning model may be referred to as a weight, attention needs to be paid in such a way that this parameter is distinguished from the first weight and the second weight, each of which is a weight for learning data.

In a learning system according to the third example embodiment, the client terminals 20x, 20y, and 20z shown in FIG. 3 are respectively replaced by client terminals 200x, 200y, and 200z. If it is not necessary to distinguish between the client terminals 200x, 200y, and 200z, they are simply referred to as a client terminal 200.

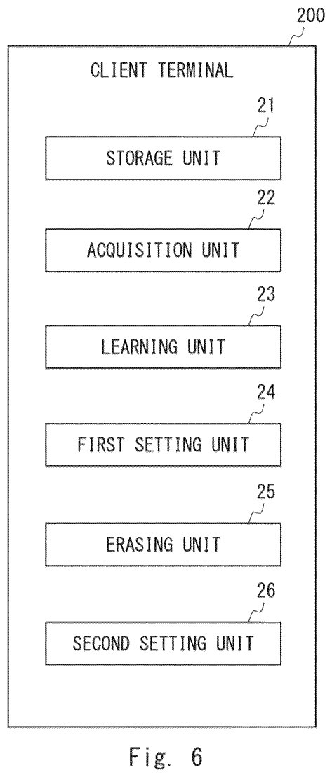

FIG. 6 is a block diagram showing a configuration of the client terminal 200. The client terminal 200 includes a storage unit 21, an acquisition unit 22, a learning unit 23, a first setting unit 24, an erasing unit 25, and a second setting unit 26.

The storage unit 21 stores blurred data acquired by the acquisition unit 22 and actual data included in data sets. Further, the storage unit 21 may store original data of the blurred data.

The acquisition unit 22 acquires blurred data for blurring predetermined data included in a data set. The acquisition unit 22 may extract blurred data from original data, or may estimate blurred data using materials informatics or the design of experiments. The acquisition unit 22 stores the acquired blurred data in the storage unit 21. The acquisition unit 22 grants a flag to the blurred data in order to identify the blurred data and the actual data included in the data sets.

The learning unit 23 performs machine learning by making the weight of blurred data (first weight) and the weight of actual data (second weight) included in the data sets different from each other, to thereby learn local models. The blurred data and the actual data may be each identified by using a flag. A method for making the weight of blurred data different from the weight of the actual data is not particularly limited. For example, the weight of data may be included in a loss function.

In a case where the first weight is greater than the second weight, predetermined data can be easily blurred. However, it is possible that the performance of local models may be degraded by blurred data, which is not the actual data. If the performance of local models is degraded, performance of the global model in which the local models are integrated is degraded as well. On the other hand, in a case where the first weight is smaller than the second weight, it is possible that the degradation in the performance of local models can be prevented but predetermined data cannot be sufficiently blurred.

Further, in a case where the reliability of the blurred data is high, it can be considered that the performance of local models will not be degraded. In this case, the first weight may be increased. On the other hand, in a case where the reliability of the blurred data is low, the performance of local models may be degraded. In this case, it is required to reduce the first weight. The case where the reliability of the blurred data is low is, for example, a case where data of the first compound has been estimated from a small amount of data.

Further, the learning unit 23 performs machine learning using blurred data and data sets stored in the storage unit 21. Since the blurred data is erased by the erasing unit 25 after an elapse of a predetermined period, the learning unit 23 does not use unnecessary blurred data in machine learning, whereby it is possible to prevent the performance of local models from degrading. That is, the learning unit 23 generates local models by machine learning that uses blurred data that has not been erased, and data sets.

The first setting unit 24 sets the first weight described above. The first setting unit 24 may set the first weight based on input to the client terminal 200. By appropriately setting the first weight, it is possible to blur predetermined data while preventing the performance of local models from being degraded by blurred data. The first weight may be set in accordance with a degree of confidentiality of the blurred data. Further, the first weight may be set in accordance with the reliability of the blurred data.

The erasing unit 25 erases the blurred data stored in the storage unit 21 after an elapse of a predetermined period. The predetermined period is set by the second setting unit 26. If the blurred data is stored for a long period of time, it is possible that the performance of local models learned in the learning unit 23 during this period may be degraded. Therefore, the blurred data is erased after an elapse of a predetermined period.

The second setting unit 26 sets the aforementioned predetermined period, that is, a period during which the blurred data is stored, based on the first weight set by the first setting unit 24. Specifically, the second setting unit 26 may set the predetermined period in such a way that the greater the first weight is, the longer the predetermined period is. In a case where the first weight is set in accordance with reliability of the first data, the less reliable the first data is, the more quickly it is erased. Therefore, it is unlikely that the performance of local models is degraded.

The learning system 100 according to the third example embodiment sets a weight of blurred data for blurring predetermined data, whereby it is possible to prevent the performance of the local models and the global model from being degraded while securing confidentiality of the predetermined data.

### Fourth Example Embodiment

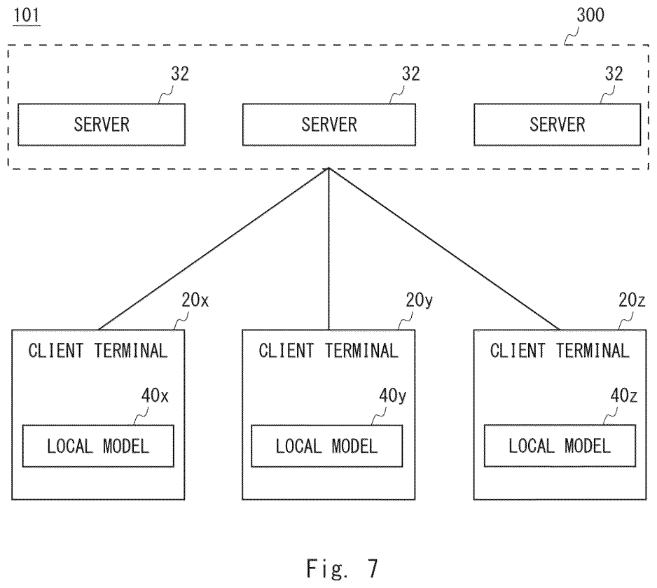

FIG. 7 is a block diagram showing a configuration of a learning system 101 according to a fourth example embodiment. FIG. 7 is different from FIG. 3 in that the server 30 shown in FIG. 3 is replaced by a server group 300 in FIG. 7. The server group 300 includes a plurality of servers 32. Note that the number of servers 32 is not limited to three. However, considering that secure computation is executed, the number of servers 32 is preferably three or greater.

The server group 300 generates a global model in secure computation and transmits a result of the secure computation to client terminals 20x, 20y, and 20z.

Like in the second example embodiment, the client terminals 20x, 20y, and 20z learn local models 40x, 40y, and 40z by machine learning that uses blurred data and data sets. Then, each of the client terminals 20 divides each model parameter of the local model 40 into a plurality of (e.g., three) shares, and transmits the plurality of shares to the plurality of servers 32.

Each server 32 performs secure computation for integrating models by using the received shares. Each server 32 may integrate models at predetermined times. The local models cannot be known from the shares, and thus computation that uses shares can be referred to as secure computation. A plurality of servers 32 may perform multi-party computation (MPC) in a collaborated manner. Since an amount of computations required to integrate local models is sufficiently small, it is considered that the server group 300 can perform secure computation in a realistic time.

The fourth example embodiment also achieves effects similar to those in the second example embodiment. Further, according to the fourth example embodiment, it is possible keep computations for integrating local models confidential.

The above-described program includes instructions (or software codes) that, when loaded into a computer, cause the computer to perform one or more of the functions described in the example embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present application has been described above with reference to the example embodiments, the present application is not limited to the above-described example embodiments. Various changes that can be understood by those skilled in the art within the scope of the present application can be made to the configurations and the details of the present application.

### REFERENCE SIGNS LIST

1, 10, 100, 101 Learning System
2, 2x, 2y, 2z, 20, 20x, 20y, 20z, 200, 200x, 200y, 200z Client Terminal
4, 4x, 4y, 4z, 40, 40x, 40y, 40zLocal Model
21 Storage Unit
11, 22 Acquisition Unit
12, 23 Learning Unit
24 First Setting Unit
25 Erasing Unit
26 Second Setting Unit
3, 30, 32 Server
13, 31 Generation Unit
300 Server Group

What is claimed is:

1. A learning system comprising:
at least one memory storing instructions and
at least one processor configured to execute the instructions to:
acquire blurred data for blurring predetermined data included in data sets owned by respective organizations;
learn local models by machine learning performed using the blurred data and the data sets; and
generate a global model in federated learning based on the local models.

2. The learning system according to claim 1, wherein
the predetermined data is data of a matter having a specific attribute, and
the blurred data is data of a matter having an attribute other than the specific attribute.

3. The learning system according to claim 1, wherein the blurred data and actual data included in the data sets are each identified using a flag.

4. The learning system according to claim 3, wherein the at least one processor is further configured to execute the instructions to:
make a weight of the blurred data in the machine learning different from a weight of the actual data.

5. The learning system according to claim 4, wherein the at least one processor is further configured to execute the instructions to:
set the weight of the blurred data.

6. The learning system according to claim 5, wherein the memory is further configured to
store the blurred data and the data sets; and the at least one processor is further configured to execute the instructions to:
erase the blurred data after an elapse of a predetermined period, and
learn the local model by machine learning performed using the blurred data that has not been erased and the data sets.

7. The learning system according to claim 6, wherein the at least one processor is further configured to execute the instructions to:
set the predetermined period based on the weight of the blurred data.

8. The learning system according to claim 1, wherein
the predetermined data is data of a compound that exhibits a specific effect, and the at least one processor is further configured to execute the instructions to:
acquire the blurred data from at least one of theoretical calculation data, experimental data, simulation data, data used for materials informatics, or data analogized by the design of experiments.

9. A learning method comprising:
acquiring blurred data, which is data for blurring predetermined data included in data sets owned by respective organizations;
causing local models to be learned by machine learning performed using the blurred data and the data sets; and
generating a global model in federated learning based on the local models.

10. A non-transitory computer readable medium storing a program for causing a computer to execute:
processing for acquiring blurred data, which is data for blurring predetermined data included in data sets owned by respective organizations;
processing for causing local models to be learned by machine learning performed using the blurred data and the data sets; and
processing for generating a global model in federated learning based on the local models.
